(19) United States
(12) Patent Application Publication
(10) Pub. No.: US 2010/0039386 A1
(43) Pub. Date: Feb. 18, 2010

(54) SLIM BACKLIGHTED KEYBOARD

(76) Inventor: Chin-Wen CHOU, Taipei Hsien (TW)

Correspondence Address: Muncy, Geissler, Olds & Lowe, PLLC, P.O. BOX 1364, FAIRFAX, VA, 22038-1364, US

(21) Appl. No.: 12/189,948

(22) Filed: Aug. 12, 2008

(51) Int. Cl. G06F 3/02

(52) U.S. Cl. 345/168; 362/26

(57) ABSTRACT

The present invention discloses a slim backlighted keyboard comprising a plurality of press members; and a support plate arranged below the press members. The support plate includes a first plane and a second plane interconnecting to each other optically. The first plane has at least one elastic support element corresponding to the press members. The second plane is on the opposite side of the first plane and has at least one light conduction groove. The light propagating inside the light conduction grooves penetrates the support plate and reaches the first plane to illuminate the press members. Thereby, the present invention can reduce the thickness of a backlighted keyboard and facilitate fabricating a slim backlighted keyboard.

### FIELD OF THE INVENTION

The present invention relates to a keyboard, particularly to a slim backlighted keyboard.

### BACKGROUND OF THE INVENTION

The keyboard is the primary input device in the current computer system, and the design of keyboards is also diversified to meet various application occasions of computer systems. For a dim or dark environment, manufacturers had developed several self-luminous keyboards to enable users to accurately press correct keys. For example, U.S. Pat. No. 5,936,554 and U.S. Pat. No. 7,278,750, Taiwan patents No. 566612 and No. 581961 respectively disclosed keyboard devices having LED inside keys, wherein each single key is illuminated by the LED thereinside, whereby users can make out the keys in a dim or dark environment. The prior arts can indeed solve the problem that users cannot recognize the keys in a dim or dark environment. However, a standard keyboard may have over one hundred keys, and the prior-art keyboard devices need the same number of LEDs, which not only increases the fabrication steps and cost but also impairs the lightweighting of keyboards. Besides, numerous LEDs consume a lot of power and generate considerable heat.

For other types of self-luminous keyboards, refer to U.S. Pat. Nos. 6,179,432, 6,199,996, 6,217,183, 6,284,988, 6,322,229, 6,554,442, 6,590,508, 6,648,530, 6,860,612, 7,235,752, 7,239,303 and 7,388,167, and Taiwan patents Nos. 509955, 516671, 587800, 594546, I230957, I231693, M240668, and M313281, wherein a backlight plate, such as an electroluminescent sheet or an optical fiber panel, is arranged over or below a baseplate of a keyboard, whereby light permeates from between the keys to enable users to make out the keys. In such a type of self-luminous keyboards, the entire keyboard is lightened by a single backlight plate, which can reduce the number of components and simplify the assemblage. Beside, the electroluminescent sheet and the optical fiber panel consume very little power and favor the long time usage of a self-luminous keyboard. A Taiwan patent No. I269333 and a U.S. patent application Ser. No. 11/288,258 disclosed a keyboard having a backlight structure, wherein a light conduction space is defined by a bridge plate and a baseplate, and at least one light conduction member is arranged in the bridge plate and corresponding to the keys, whereby the light conduction members receive the light entering the light conduction space and conduct the light to the key region.

### SUMMARY OF THE INVENTION

The primary objective of the present invention is to reduce the thickness of a backlighted keyboard and facilitate fabricating a slim backlighted keyboard. To achieve the abovementioned objective, the present invention proposes a slim backlighted keyboard comprising a plurality of press members and a support plate. The support plate is arranged below the press members and further comprises a first plane and a second plane, which interconnect to each other optically. The first plane has at least one elastic support element corresponding to the press members. The second pane is on the opposite side of the first plane and has at least one light conduction groove. The light propagating in the light conduction groove can penetrate the support plate and reach the first plane to illuminate the press members.

The first plane has an actuation mechanism corresponding to the press members, and the elastic support element is arranged inside the actuation mechanism. Light emitting elements are arranged in the ends of the light conduction grooves or inside the light conduction grooves. The light conduction groove has at least one reflection face thereinside; the reflection face and the second plane contain a reflection angle. The light conduction groove has a V-shape or U-shape section.

The support plate is made of a transparent material, and the first plane and second plane of the support plate interconnect to each other optically, whereby light can transmit from the second plane to the first plane or vice versa. Alternatively, at least one light conduction member is arranged in between the first plane and the second plane, whereby light can be transmitted from the second plane to the first plane.

The slim backlighted keyboard of the present invention uses only few light emitting elements to lighten the entire keyboard. Further, the present invention equips with light conduction grooves on the support plate to save light-conduction space and devices, such as an electroluminescent sheet or an optical fiber panel. Thus, the number of light emitting components is reduced, and the thickness of the entire keyboard is decreased. Therefore, the present invention can facilitate the fabrication of a slim backlighted keyboard.

### BRIEF DESCRIPTION OF THE DRAWINGS

FIG. 1 is an exploded view of a slim backlighted keyboard according to a preferred embodiment of the present invention;

FIG. 2 is a perspective view of a slim backlighted keyboard according to a preferred embodiment of the present invention;

FIG. 3 is a sectional view along Line 3-3 shown in FIG. 2;

FIG. 4 is a sectional view along Line 4-4 shown in FIG. 2;

FIG. 5 is a sectional view showing that the light conduction groove has only a single reflection face according to another preferred embodiment of the present invention;

FIG. 6 is a diagram schematically showing light emitting elements are arranged inside the light conduction grooves according to still another preferred embodiment of the present invention; and

FIG. 7 is a sectional view of a slim backlighted keyboard according to a further preferred embodiment of the present invention.

### DETAILED DESCRIPTION OF THE PREFERRED EMBODIMENTS

Below, the technical contents of the present invention are described in detail in cooperation with the drawings.

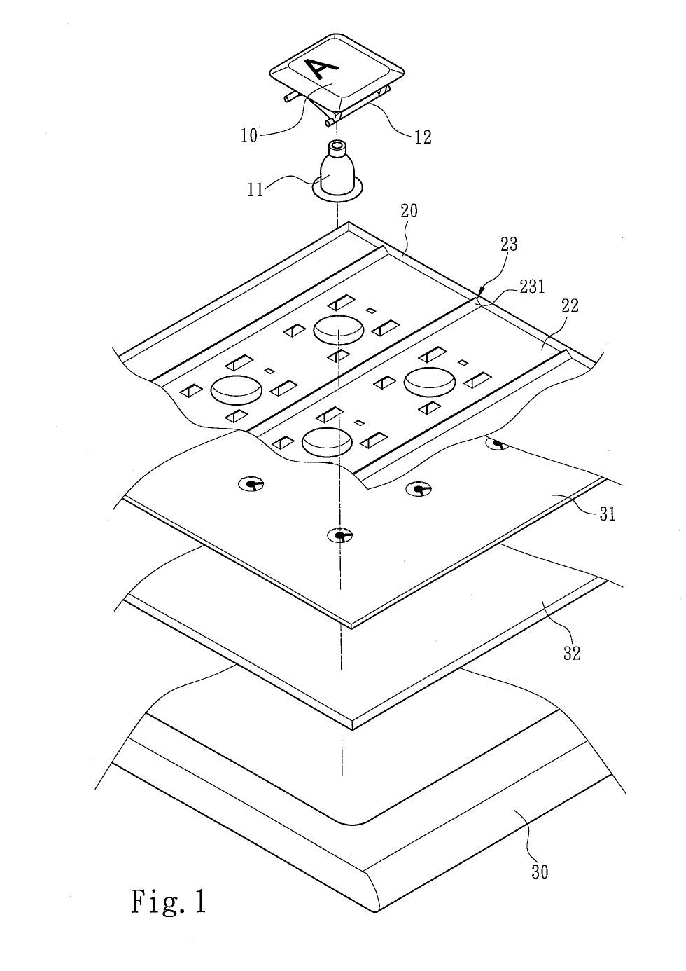

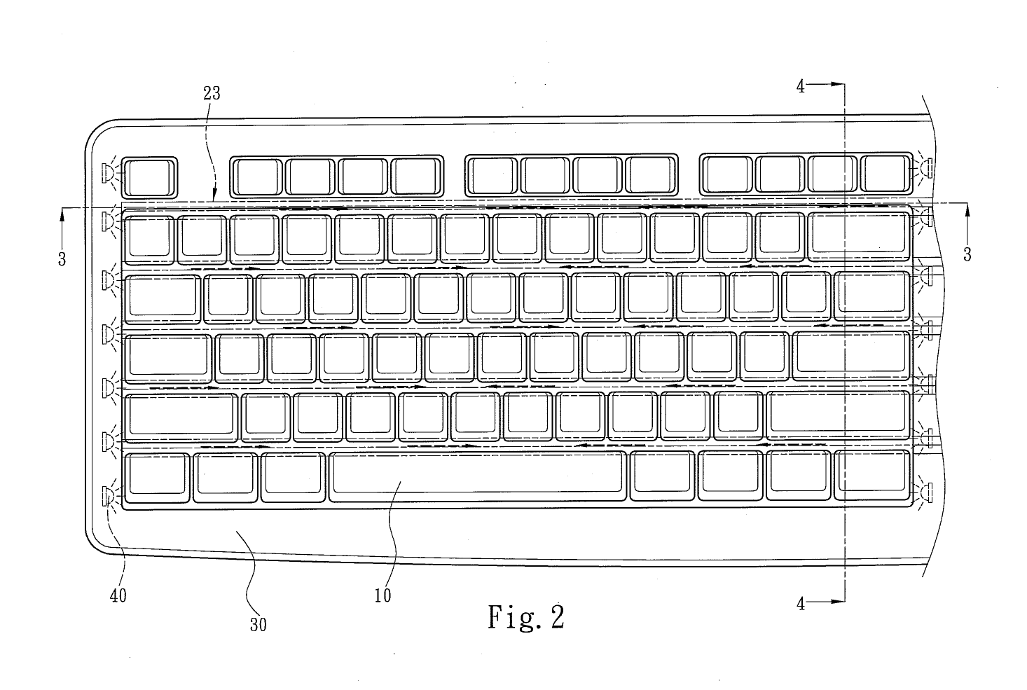

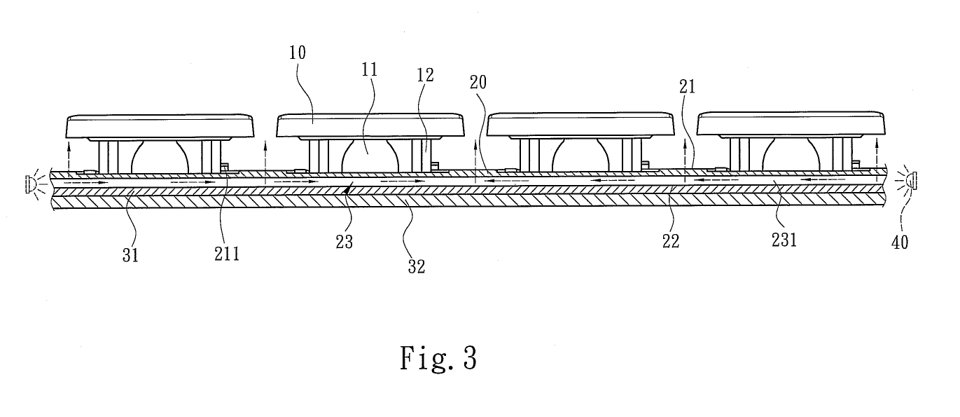

Refer to FIG. 1, FIG. 2 and FIG. 3 respectively an exploded view, a perspective view and a sectional view of a slim backlighted keyboard according to the present invention. The slim backlighted keyboard of the present invention comprises a plurality of press members 10 and a support plate 20 arranged below the press members 10 and carrying the press members 10. The press members 10 and the support plate 20 are arranged inside a casing 30. The support plate 20 further comprises a first plane 21 and a second plane 22, which interconnect to each other optically, whereby light can be transmitted between the first plane 21 and the second plane 22. The embodiment shown in the drawings adopts a scissors-type keyboard structure. However, the present invention is not limited thereto. The first plane 21 has at least one elastic support element 11 and at least one actuation mechanism 12 corresponding to the press members 10. The elastic support element 11 is arranged inside the actuation mechanism 12. Two ends of the actuation mechanism 12 are respectively connected to the press member 10 and the support plate 20. The first plane 21 of the support plate 20 has fix members 211 used to fix the actuation mechanisms 12. In this embodiment, a circuit board 31 generating instruction signals and a baseplate 32 carrying the abovementioned components are arranged below the support plate 20.

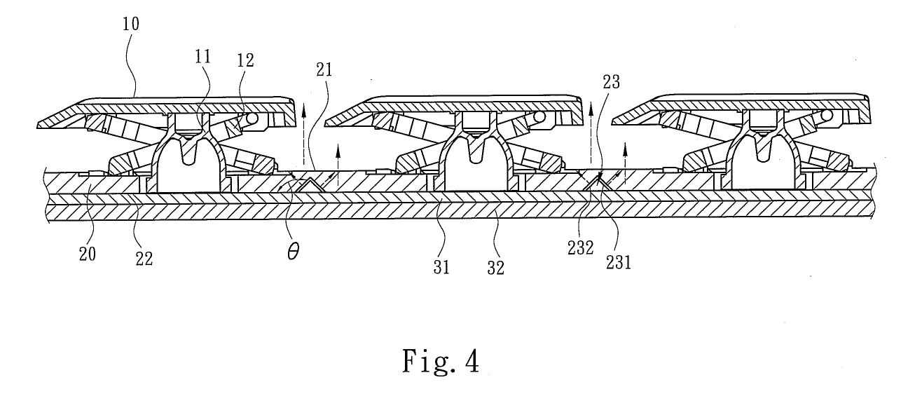

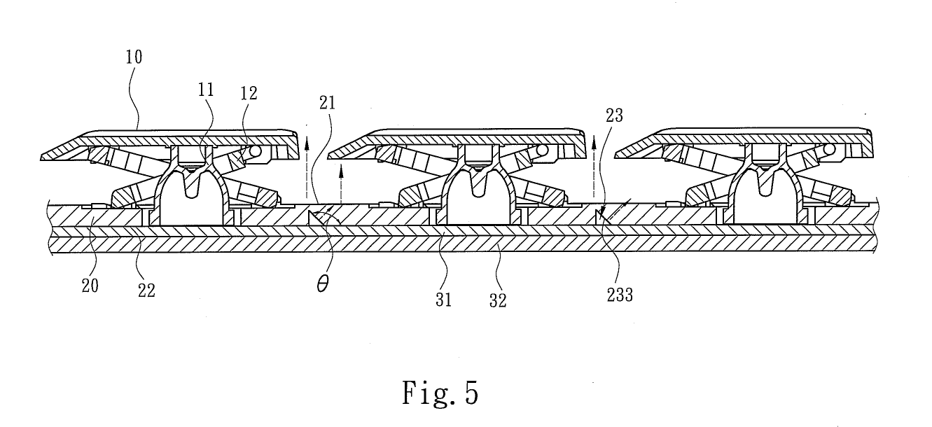

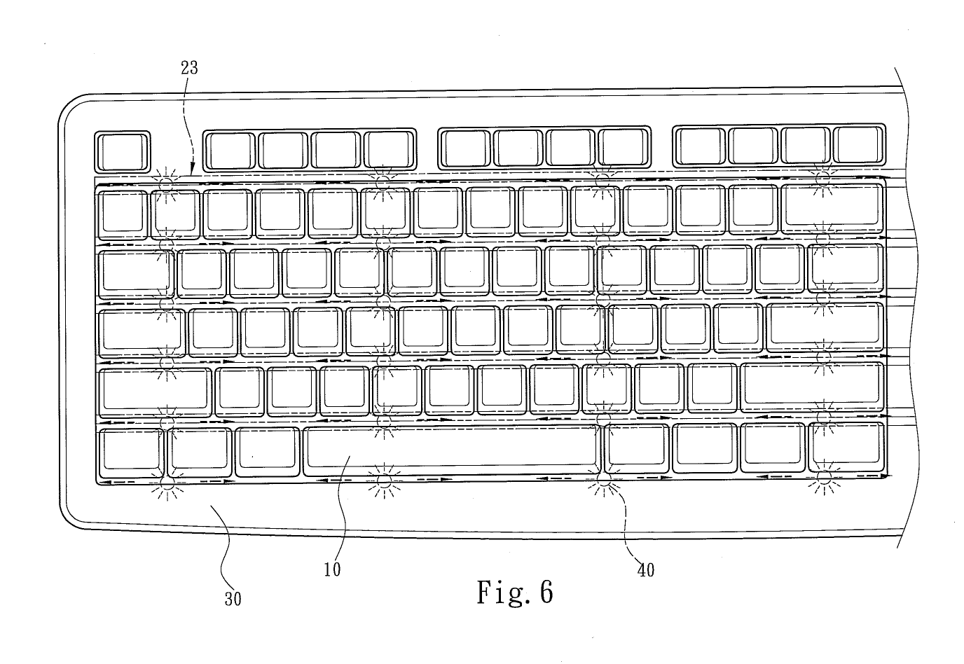

Refer to FIG. 1, FIG. 3 and FIG. 4. In the present invention, the second plane 22 of the support plate 20 is on the opposite side of the first plane 21. The second plane 22 has at least one light conduction groove 23, and light propagates in the light conduction groove 23. In this embodiment, the light conduction groove 23 has a V-shape or U-shape section and has at least one reflection face thereinside. In this embodiment, the light conduction groove 23 has a first reflection face 231 and a second reflection face 232. The second plane 22 and the first reflection face 231/second reflection face 232 contain a reflection angle θ, and the reflection angle θ is between 0 and 180 degrees. Refer FIG. 5. Alternatively, the light conduction groove 23 has only a single reflection face 233. The second plane 22 and the reflection face 233 contain a reflection angle θ, and the reflection angle θ is between 0 and 180 degrees. Light emitting elements 40 are arranged inside the casing 30 and provide light for the light conduction grooves 23. After entering the light conduction grooves 23, light propagates in the light conduction grooves 23 on the second plane 22. The light emitting element 40 may be LED (Light Emitting Diode) or LD (Laser Diode). In this embodiment, the light emitting elements 40 may be arranged in the ends of the light conduction grooves 23 (as shown in FIG. 2) or inside the light conduction grooves 23 (as shown in FIG. 6).

The second plane 22 interconnects with the first plane 21 optically. As shown in FIG. 3, the support plate 20 is made of a transparent material, such as PVC (polyvinyl chloride), PMMA (polymethylmethacrylate), PU (polyurethane), PS (poly styrene), PET (polyethylene terephthalate), or silicone. Thus, the light propagating in the second plane 22 can directly penetrate the second plane 22 or vertically penetrate the surfaces of the light conduction grooves 23 and then reach the first plane 21 to illuminate the press members 10.

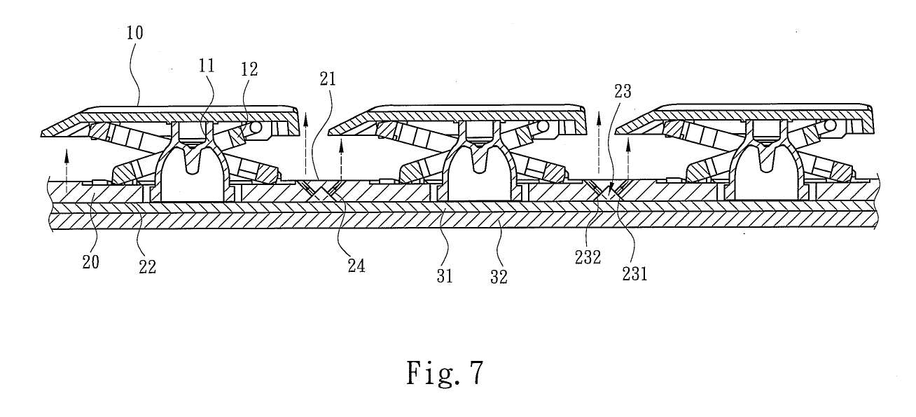

Refer to FIG. 7. In another embodiment, at least one light conduction member 24 is arranged in the support plane 20 and between the first and second planes 21 and 22, whereby light can travel to and fro between the first plane 21 and the second plane 22. Alternatively, the light conduction members 24 are arranged in between the light conduction grooves 23 and the first plane 21, whereby the light conduction members 24 conduct the light propagating in the light conduction grooves 23 to the first plane 21 to lighten the space between the first plane 21 and the press members 10 and backlight the entire keyboard.

In the slim backlighted keyboard of the present invention, the light conduction grooves enable the light generated by the light emitting elements to propagate in the second plane of the support plate. As the second plane interconnects to the first plane optically, the light is vertically conducted to the first plane and then lightens the space between the first plane and the press members. Thereby, the press members have such a brightness that users can make out the press members. The present invention does not use an additional light conduction layer but uses only few light emitting elements to lighten the entire keyboard, whereby the number of light emitting components is reduced and the thickness of the entire keyboard is decreased. Then, the present invention can facilitate the fabrication of a slim backlighted keyboard. Therefore, the present invention possesses novelty and non-obviousness and meets the conditions for a patent. Thus, the Inventor files the application for a patent. It will be appreciated if the patent is approved fast.

The embodiments described above are only to exemplify the present invention but not to limit the scope of the present invention. Therefore, any equivalent modification or variation according to the spirit of the present invention is to be also included within the scope of the present invention.

What is claimed is:

1. A slim backlighted keyboard comprising
a plurality of press members; and
a support plate arranged below said press members and including a first plane and a second plane interconnecting to each other optically, wherein said first plane has at least one elastic support element corresponding to said press members, and wherein said second plane is on the opposite side of said first plane and has at least one light conduction groove, and light propagating inside said light conduction grooves penetrates said support plate and reaches said first plane to illuminate said press members.

2. The slim backlighted keyboard according to claim 1, wherein said support plate is made of a transparent material.

3. The slim backlighted keyboard according to claim 1, wherein at least one light conduction member is arranged in between said first plane and said second plane.

4. The slim backlighted keyboard according to claim 3, wherein said light conduction member is arranged in between said first plane and said light conduction groove.

5. The slim backlighted keyboard according to claim 1, wherein said first plane has an actuation mechanism corresponding to said press members, and said elastic support element is arranged inside said actuation mechanism.

6. The slim backlighted keyboard according to claim 1, wherein said light conduction groove has a V-shape section.

7. The slim backlighted keyboard according to claim 1, wherein said light conduction groove has a U-shape section.

8. The slim backlighted keyboard according to claim 1, wherein said light conduction groove has at least one reflection face thereinside.

9. The slim backlighted keyboard according to claim 1, wherein said reflection face and said second plane contain a reflection angle.

10. The slim backlighted keyboard according to claim 1, wherein a light emitting element is arranged in one end of said light conduction groove.

11. The slim backlighted keyboard according to claim 1, wherein a light emitting element is arranged inside said light conduction groove.
